(19) United States
(12) Patent Application Publication
(10) Pub. No.: US 2006/0073848 A1
(43) Pub. Date: Apr. 6, 2006

(54) Mobile communication device

(75) Inventor: Jong Hun Kwon, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/243,740

(22) Filed: Oct. 4, 2005

(30) Foreign Application Priority Data
Oct. 4, 2004 (KR) 10-2004-0078670

(51) Int. Cl. H04B 1/38

(52) U.S. Cl. 455/558; 455/550.1

(57) ABSTRACT

A mobile communication device is disclosed, by which configurations of loaded antenna and card are enhanced. The present invention includes a body including elements performing wireless mobile communications and auxiliary functions, a socket provided to one side of the body to compensate functions of the body and to detachably receive a card for storing data, and a plane type antenna connected to a rim of the socket to transmit/receive wireless communication signals.

This application claims the benefit of the Korean Patent Application No. 10-2004-0078670, filed on Oct. 4, 2004, which is hereby incorporated by reference as if fully set forth herein.

### BACKGROUND OF THE INVENTION

1. Field of the Invention

The present invention relates to a mobile communication device. Although the present invention is suitable for a wide scope of applications, it is particularly suitable for loading a card in the mobile communication device.

2. Discussion of the Related Art

Generally, a mobile communication device such as a mobile phone, a PDA and the like is a device for delivering voice information. Recently, technological developments of mobile communication devices such as a mobile phone, PDA and the like provide character information, image information, games and the like to a user as well as simple voice information.

Lately, a mobile communication device is provided with an audio player function of playing back audio files such as MP3 files and the like and a digital camera function of capturing digital photos and videos. Hence, the mobile communication device of which usage scope is gradually expanding becomes the necessity of life.

As the application field of the mobile communication device is more extended, a card for performing various functions or storing data is detachably provided to one side of the mobile communication card.

FIG. 1 is a perspective diagram of a mobile communication device according to a related art.

Referring to FIG. 1, a card loading socket 4 is separately provided to a body 1 of the mobile communication device so that a separate card 5 can be selectively loaded in the socket 4 to fit various user's tastes in using the mobile communication device.

The card 5 loaded in the mobile communication device can be categorized into a smart card and a memory card. By storing information of various authentication, information of a credit card for payment, information of a passbook and the like in a smart card, the commerce-phone can be provided with financially-associated functions as an electronic passbook for transactions including account inquiry, money wiring, cash-out, check inquiry and the like as well as the function of a transportation or credit card. Moreover, by applying a near communication module such as an infrared transmission to the commerce-phone, a smart card payment via wireless communications can be realized.

The convergence of the smart card and mobile communication device is also applicable to a case that the smart card is used as a subscriber identity module to provide a roaming service of the mobile communication device. As a smart card, there are SIM (subscriber identity module) card, USIM (universal subscriber identity module) card, UIM (user identity module) card, RUIM (removable user identity module) card, etc.

Meanwhile, as functions of mobile communication devices including mobile phones are diversified and expanded, their demanded storage capacities are increased. For instance, in case of a mobile phone provided with a digital camera function of photographing to store images and/or an MP3 player function, additional memory capacity added to intrinsic storage capacity of the mobile phone is considerably needed to store photograph data and MP3 files.

There are variously developed types of memory cards. And, most of the memory cards employ flash memory. For instance, there are standardized memory cards such as secure digital (SD) card, memory stick (MS) card, smart media card (SMC), compact flash card (CFC), multimedia card (MMC), etc.

Yet, the memory or smart card built in the body of the mobile communication device raises the price of the device and becomes useless for a user who intends not to use the memory or smart card. Hence, it is preferable that the card is not built in the mobile communication device.

A socket 4, as shown in FIG. 1, is provided to one side of the body 1 so that the card 5 can be detachably fitted therein. After the card has been fitted in the socket 4, an entrance of the socket 4 is closed by a separate cover 6. In this case, the cover 6 is formed of such an elastic or flexible material as a rubber and one side of the cover 6 is joined to one lateral side of the body 1.

And, an antenna 7 protrudes in an upper direction from one upper side of the body 1 to transmit/receive radio communication waves. Moreover, a lower part of the antenna 7 is joined to one side of the body 1 to be assembled thereto and a lower end of the antenna 7 extends downwardly within an inside of the body 1 to be electrically connected to a transmitting and receiving part of radio communication signals.

However, the related art mobile communication device has the following problems.

First of all, the rubber-based cover breaks due to long-term use. If the connecting portion between the cover and the body is broken, the rubber-based cover is detached from the device to be lost.

Secondly, since the antenna is upwardly projected from the body, it is inconvenient for a user to carry the mobile communication device. Namely, if the mobile communication device is put in a user's pocket to be carried, the connecting portion between the antenna and the body is easily broken.

### SUMMARY OF THE INVENTION

Accordingly, the present invention is directed to a mobile communication device that substantially obviates one or more problems due to limitations and disadvantages of the related art.

An object of the present invention is to provide a mobile communication device, by which configurations of loaded antenna and card are enhanced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile communication device according to the present invention includes a body including elements performing wireless mobile communications and auxiliary functions, a socket provided to one side of the body to compensate functions of the body and to detachably receive a card for storing data, and a plane type antenna connected to a rim of the socket to transmit/receive wireless communication signals.

Preferably, the plane type antenna selectively opens/closes an entrance of the socket. The plane type antenna slides along one lateral side of the body. A guide portion recessed inward is provided to the one lateral side of the body to guide a movement of the plane type antenna. Guide grooves are provided to both sides of the guide portion, respectively and fitting protrusions are provided to both sides of the plane type antenna to be fitted in the guide grooves, respectively.

More preferably, the socket is provided to an upper part of one lateral side of the body and the plane type antenna projects from an upper side of the body to be fixed thereto when the socket is open. A hanging protrusion is provided to the plane type antenna and a hanging recess is provided to an upper part of the socket to lock the hanging protrusion therein.

Preferably, one end of the plane type antenna is rotatably connected to one lateral side of the body and the other end of the plane type antenna is selectively fixed to the one lateral side of the body. The plane type antenna is rotated centering on a rotational axis parallel to the one lateral side of the body.

More preferably, a guide portion recessed inward is provided to the one lateral side of the body to receive the plane type antenna therein.

One end of the plane type antenna is joined to the one lateral side of the body using a hinge and the other end of the plane type antenna is selectively fixed to the one lateral side of the body using a hook. If the plane type antenna is fully turned upwardly, the plane type antenna is held by the one lateral side of the body to sustain an upwardly projecting posture.

Preferably, the plane type antenna comprises a micro-strip board. A first terminal is exposed within the socket and a connecting terminal of the card is clamped between the first terminal and an inner lateral side of the socket to be fixed thereto.

In another aspect of the present invention, a mobile communication device includes a body including elements performing wireless mobile communications and auxiliary functions, a socket provided to one side of the body to compensate functions of the body and to detachably receive a card for storing data, and a plane type antenna sliding to move along a guide portion to open/close the socket and to transmit/receive wireless communication signals wherein the guide portion is recessed inward from a rim of the socket to guide a movement of the pane type antenna.

In a further aspect of the present invention, a mobile communication device includes a body including elements performing wireless mobile communications and auxiliary functions, a socket provided to one side of the body to compensate functions of the body and to detachably receive a card for storing data, a plane type antenna opening/closing an entrance of the socket, the plane type antenna having one end rotatably connected centering on a rotational axis parallel to one lateral side of the body and the other end selectively fixed to the one lateral side of the body, the plane type antenna transmitting/receiving wireless communication signals, and a guide portion recessed inward from a rim of the socket to receive the pane type antenna therein.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a perspective diagram of a mobile communication device according to a related art;

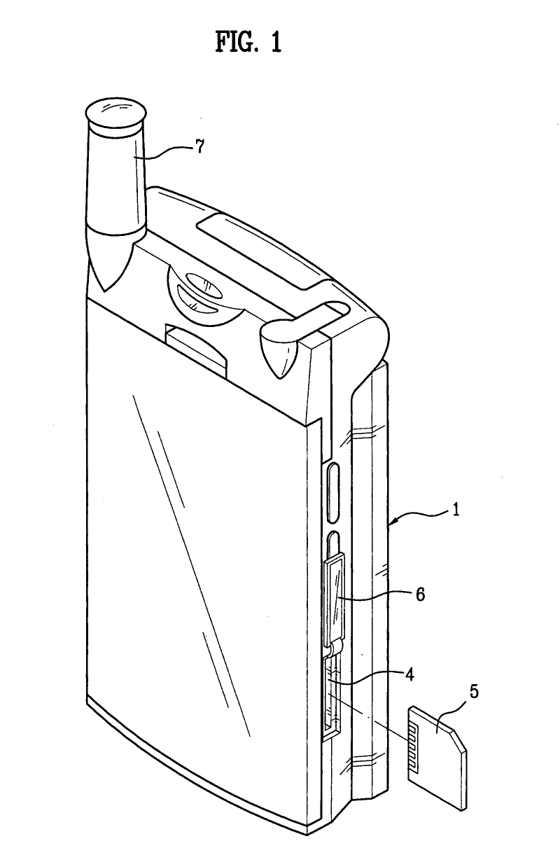

FIG. 2 illustrates a perspective diagram of a mobile communication device according to one embodiment of the present invention;

FIG. 3 illustrates a perspective diagram of a mobile communication device according to the present invention, in which an entrance of a socket is closed;

FIG. 4 illustrates a cross-sectional diagram along a cutting line I-I′ in FIG. 3;

FIG. 5 illustrates a perspective diagram of a mobile communication device according to the present invention, in which an entrance of a socket is open;

FIG. 6 illustrates a cross-sectional diagram along a cutting line II-II′ in FIG. 5;

FIG. 7 illustrates a perspective diagram of a mobile communication device according to another embodiment of the present invention; and

FIG. 8 illustrates a cross-sectional diagram along a cutting line III-III′ in FIG. 7.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

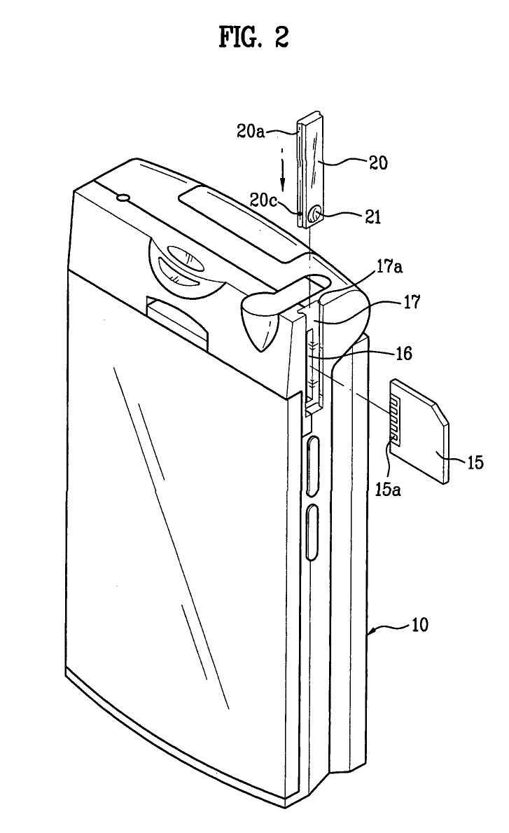

First of all, mobile communication devices according to embodiments of the present invention are explained in detail with reference to FIGS. 2 to 7 as follows.

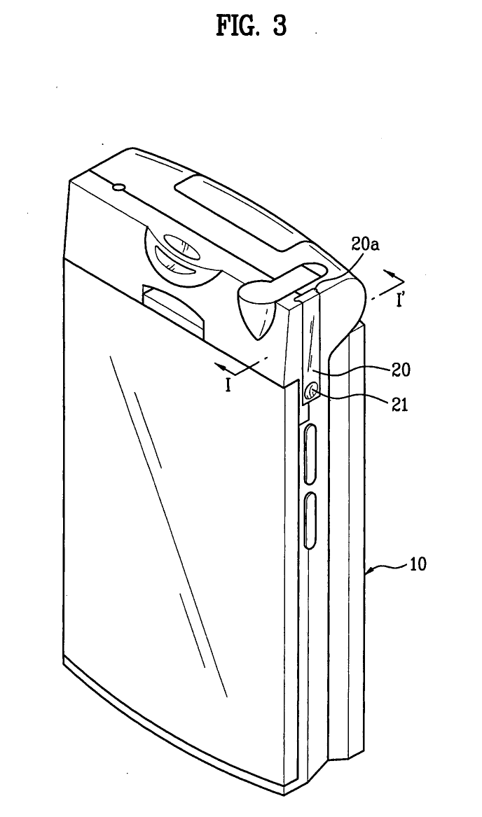

FIG. 2 is a perspective diagram of a mobile communication device according to one embodiment of the present invention. FIG. 3 is a perspective diagram of a mobile communication device according to the present invention, in which an entrance of a socket is closed by a plane type antenna.

Referring to FIG. 2 and FIG. 3, a mobile communication device according to one embodiment of the present invention includes a body 10, a socket 16, a card 15, and a plane type antenna 20.

In this case, various elements for performing wireless mobile communications and auxiliary functions are provided to the body 10. A main board electrically connecting a radio communication signal transmitting/receiving unit and a display together is provided within the body 10. And, a control unit, a built-in memory, a mobile communication signal processing unit and the like are provided to the main board.

The mobile communication signal processing unit includes a transmitting signal processing unit and a receiving signal processing unit. The transmitting signal processing unit processes to transmit information inputted via a signal input/output unit and information stored in the built-in memory. And, the receiving signal processing unit receives to process radio waves received from outside.

Configurations of the radio communication signal transmitting/receiving unit, display, camera module, control unit, built-in memory, mobile communication signal processing unit and the like provided to the body 10 are the same of the elements provided to a general mobile communication device, of which explanation will be skipped.

A battery supplying electric power is detachably provided to a rear side of the body 10, while various buttons for operating the device are provided to a front side of the body 10. A folder part is rotatably provided to the front side of the body 10. And, a display means such as LCD (liquid crystal display) for displaying an operational status of the device is provided to the folder part. It is a matter of course that auxiliary devices such as a camera module (not shown in the drawing) can be further provided to the body 10.

Meanwhile, the socket 16 is provided to one lateral side of the body 10. And, the card 15, which compensates functions of the body 10 and stores data therein, is detachably inserted in the socket 16. The card 15 is categorized into a smart card compensating various functions of the device and a memory card storing data. In this case, the socket 16 can be provided to each lateral side of the body 10, whereby various kinds of cards can be inserted in the sockets.

In this case, smart cards including SIM (subscriber identity module) card, USIM (universal subscriber identity module) card, UIM (user identity module) card, RUIM (removable user identity module) card, etc. can be inserted and loaded.

And, memory cards including secure digital (SD) card, memory stick (MS) card, smart media card (SMC), compact flash card (CFC), multimedia card (MMC), etc. can be inserted and loaded. Shapes of the respective cards are standardized according to their species, respectively. And, an inner shape of the socket 16 is preferably configured to consider compatibility of each of the various species of the cards.

A first terminal (not shown in the drawing) connected to a connecting terminal 15a that is provided to the card 15 is exposed within the socket 16. The connecting terminal inserted in the socket 16 is electrically connected to the first terminal so that the car 15 can perform a function determined through signal exchange with the body 10.

Meanwhile, after the card 15 has inserted and loaded in the socket 15, an entrance of the socket 16 needs to be closed to prevent external particles from entering an inside of the socket 16. In this case, the entrance of the socket 16 is preferably opened/closed by the plane type antenna 20.

The plane type antenna 20 preferably includes a micro-strip substrate. The micro-strip substrate includes an insulator and a pair of conductive plates attached to both sides of the insulator, respectively. In this case, one of the conductive plates is formed of a strip (steel sheet). And, the strip and the conductive plate become wires for supplying electricity. In this case, if a width of the strip is raised, a frequency bandwidth is widened to facilitate radiation of radio waves. Besides, the micro-strip antenna is fabricated using a printed board, thereby fitting mass production. And, a height of the micro-strip antenna is mall and the micro-strip antenna has a planar shape. So, the micro-strip antenna is advantageous in robustness.

Meanwhile, the plane type antenna 20 slides to move along one lateral side of the body 10, thereby selectively opening/closing the entrance of the socket 16. Hence, the plane type antenna carries out a function of a cover opening/closing the entrance of the socket 16 as well as a function of an antenna for transmitting/receiving radio communication waves. Therefore, the plane type antenna 20 contributes to the reduction of the overall volume of the mobile communication device.

The plane type antenna 20 according to one embodiment of the present invention moves upward and downward along one lateral side of the body 10 in the following manner.

First of all, the plane type antenna 20, as shown in FIG. 3, moves downward along one lateral side of the body 10 to close the entrance of the socket 16. In case that the socket 16 is completely closed by the plane type antenna 20, it is able to prevent external dust or moisture from entering the socket 16. In this case, it is preferable that an outer lateral side of the plane type antenna 20 coincides with an outer surface of the body 10 to maintain a continuous exterior of the body 10.

For this, a guide portion 17 recessed inside is provided to one lateral side of the body 10 to receive the plane type antenna 20 therein. The guide portion 17 holds both right and left lateral sides of plane type antenna 20 and simultaneously guides the motion of the plane type antenna 20.

Moreover, a recess portion 21 is formed at a lower part of an outer lateral side of the plane type antenna 20. Hence, if a user presses the recess portion 21 and pushes the plane type antenna 20 upwardly, the plane type antenna 20 upwardly slides to move. Alternatively, the recess portion 21 can be replaced by a projection.

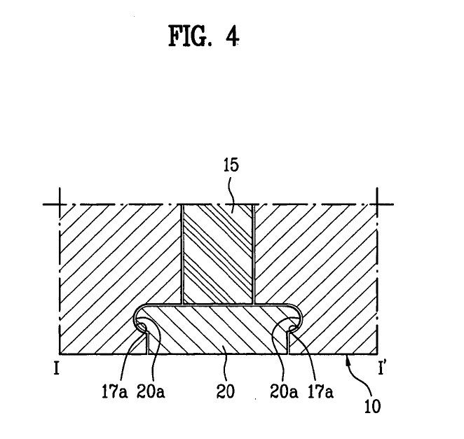

FIG. 4 is a cross-sectional diagram along a cutting line I-I′ in FIG. 3.

Referring to FIG. 4, guide grooves 17a are formed at both sides of the guide portion 17, respectively. And, fitting protrusions 20a are provided to both sides of the plane type antenna 20 to be fitted in the guide grooves 17a, respectively. Hence, the fitting protrusions 20a are held by the guide grooves 17a to prevent the plane type antenna 20 from being detached outside and to guide the plane type antenna 20 to slide upwardly and downwardly.

Meanwhile, if the radio communication wave in the area where the mobile communication device is used is weak, i.e., if the mobile communication device lies in a weak electric field, the antenna is pushed upward to reinforce intensity of the electric field for communications. If the intensity of the electric field is reinforced, a transmission/reception ratio of radio waves can be enhanced.

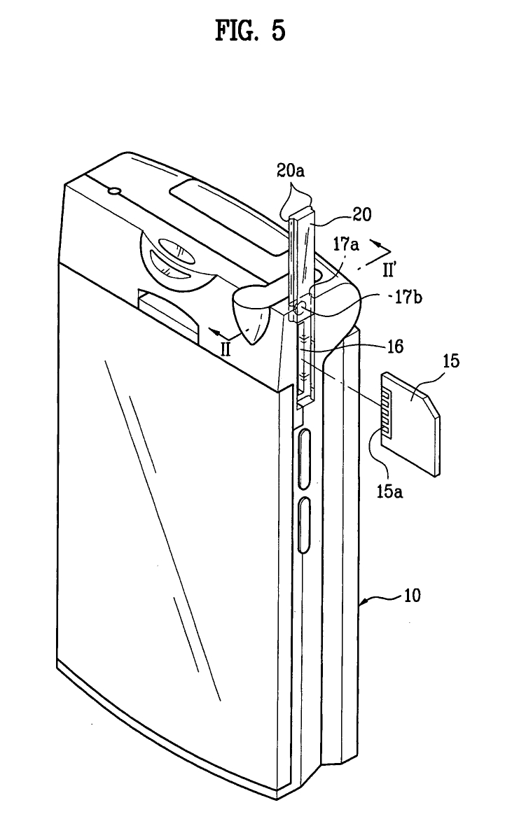

FIG. 5 is a perspective diagram of a mobile communication device according to the present invention, in which a plane type antenna is upwardly projected.

Referring to FIG. 5, to enhance a radio wave transmission/reception ratio of the mobile communication device, the plane type antenna 20 upwardly slides to be projected from an upper side of the body 10. And, such a state is preferably fixed. In doing so, the plane type antenna 20 is projected from the upper side of the body 10 to be fixed thereto while the entrance of the socket 16 is open.

In this case, to prevent the detachment or separation of the card 15, the first terminal (not shown in the drawing) is exposed within the socket 16 and the connecting terminal 15a of the card 15 is clamped between the first terminal and an inner lateral side of the socket 16 to be fixed thereto. Hence, the card 15 is unable to escape from the socket 16 even if the entrance of the socket 16 is open due to the plane type antenna 20 projected from the upper side of the body 10.

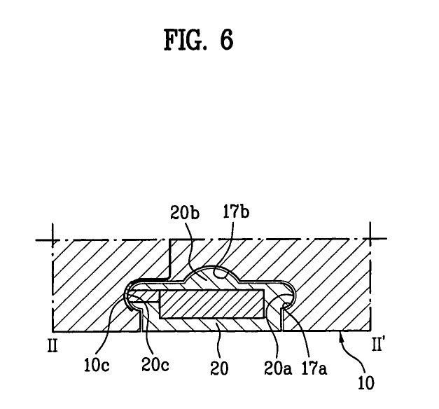

FIG. 6 is a cross-sectional diagram along a cutting line II-II′ in FIG. 5.

Referring to FIG. 6, to sustain the state that the plane type antenna 20 is projected from the upper side of the body 10, a hanging protrusion 20b is provided to an inner lateral side of the plane type antenna 20 and a hanging recess 17b is provided to an upper rim of the socket 16 to have the hanging protrusion 20b inserted therein to be locked therein.

The hanging protrusion 20b is provided to a lower part of the inner lateral side of the plane type antenna 20 to freely move upward and downward while being inserted in the socket 16. If the plane type antenna 20 keeps sliding upwardly, the hanging protrusion 20b is fitted in the hanging recess 17b to be fixed thereto. In this case, the hanging recess 17b has a predetermined depth from an outer lateral side of the body 10 and the rim of the socket 16 holds the hanging protrusion 20b fitted in the hanging recess 17b. Hence, it is able to prevent the plane type antenna 20, which is fitted in the hanging recess 17b, from moving downwardly.

Thereafter, if the plane type antenna 20 is downwardly pressurized by a prescribed force enough for the hanging protrusion 20b to escape from the held state to lower the plane type antenna 20, the hanging protrusion 20b passes through a step difference and then slides downwardly to re-enter the socket 16.

Alternatively, the hanging protrusions can be provided to both lateral sides of the plane type antenna 20, i.e., the fitting protrusions 20a, respectively. In this case, it is preferable that the hanging recess is provided over each of the guide grooves 17a.

By the above-explained configuration of the embodiment of the present invention, the plane type antenna is able to cover the card loaded in the slot or can be selectively projected from the upper side of the body.

Meanwhile, at least one terminal 20c is provided at the antenna 20 as shown in FIG. 2 and at least one terminal 10c is provided at the body 10 as shown in FIG. 6 in order to electrically connect the antenna 20 with the radio communication signal transmitting/receiving unit (not shown) in the body 10.

The terminal 20c is electrically connected with a body of the antenna 20. The terminal 20c may be provided at the lower part of the plane type antenna 20 and be arranged on one side of the plane type antenna 20 as shown in FIG. 2. Alternatively, the terminal 20c may be arranged on both sides of the plane type antenna 20 even if not shown in the drawings.

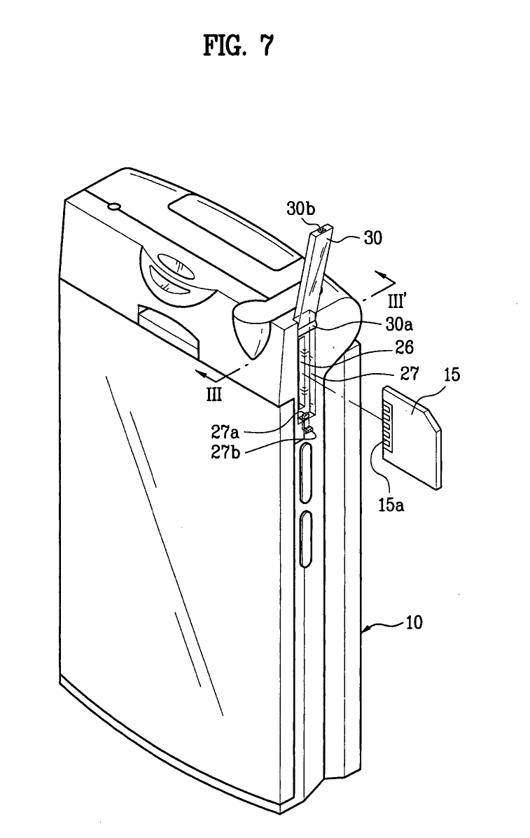

The terminal 10c is electrically connected the radio communication signal transmitting/receiving unit in the body 10 by a lead wire. The terminal 10c is arranged at the guide portion 17, especially on the guide groove 17a as shown in FIG. 7. The terminal 10c may be provided at a lower portion of the guide groove 17a and at an upper portion of the guide groove 17a, respectively.

In this case, the terminal 20c contacts with the terminal 10c at the lower portion of the guide groove 17a when the antenna 20 closes the entrance of the socket 16 as shown in FIG. 3, and the terminal 20c contacts with the terminal 10c at the upper portion of the guide groove 17a when the antenna 20 is projected from the body 10 to open the entrance of the socket 16 as shown in FIG. 5.

Alternatively, the terminal 10c may be provided from the lower portion of the guide groove 17a to the upper portion of the guide groove 17a. In this case, the terminal 20c contacts with the terminal 10c while the antenna 20 opens/closes the entrance of the socket 16.

FIG. 7 is a perspective diagram of a mobile communication device according to another embodiment of the present invention.

Referring to FIG. 7, one end of a plane type antenna 30 is rotatably provided to one side of a body 10. For this, one end 30a of the plane type antenna 30 is joined to one lateral side of the body 10 using a hinge.

Specifically, the plane type antenna 30 is rotatably provided centering on a rotational shaft parallel to one lateral side of the body 10. In case of being fully turned upward, the plane type antenna 30 is held by an upper part of one lateral side of the body 10. Thus, the plane type antenna 30 can sustain a state of being upwardly projected.

The other end of the plane type antenna 30 is selectively fixed to one lateral side of the body 10. Namely, if the plane type antenna 30 is rotated centering on one end 30a after the other end of the plane type antenna 30 has been separated from one lateral side of the body 10, an entrance of a socket 26 becomes open.

To form a continuous exterior between one lateral side of the body 10 and an outer lateral side of the plane type antenna 30, a guide portion 27 is provided to the entrance of the socket 26 so that the plane type antenna 30 can be inserted therein. The guide portion 27 is recessed inward from one lateral side of the body 10 so that the plane type antenna 30 is inserted therein. In this case, it is preferable that a recessed depth of the guide portion 27 is set equal to a thickness of the plane type antenna 30.

Hence, to close the entrance of the socket 26, once the plane type antenna 30 is inserted in the guide portion 27, one lateral side of the body 10 forms a continuous shape together with the outer lateral side of the plane type antenna 30.

Meanwhile, the other end of the plane type antenna 30 is preferably locked to one lateral side of the body 10 using a hook.

A hook 27a, as shown in FIG. 7, is provided to a lower side rim of the guide portion 27 and a recess portion 30b is formed at the other end of the plane type antenna 30. In order to close the entrance of the socket 26, a user puts the other end of the plane type antenna 30 on an upper side of the hook 27a and then presses the plane type antenna 30 with a prescribed force. If so, the hook 27a is fitted in the recess portion 30b to be locked therein.

On the other hand, in case of opening the entrance of the socket 26, a button 27b provided to a rear end of the hook 27a is pulled downward to separate the hook 27a from the recess portion 30b and the plane type antenna 30 is then turned upwardly.

In this case, the locations and shapes of the hook 27a and recess portion 30b are not limited to the above-explained embodiment of the present invention but can be variously modified by those who skilled in the art.

Meanwhile, the socket 26 is provided to an upper part of one lateral side of the body 10. When the socket 26 is open, it is preferable that the plane type antenna 30 is projected from an upper side of the body 10.

If the radio communication wave in the area where the mobile communication device is used is weak, i.e., if the mobile communication device lies in a weak electric field, the antenna is pushed upward to reinforce intensity of the electric field for communications. If the intensity of the electric field is reinforced, a transmission/reception ratio of radio waves can be enhanced.

While the plane type antenna 30 is projected upwardly, the entrance of the socket 26 is open. In this case, to prevent the detachment or separation of the card 15 fitted in the socket 26, a first terminal (not shown in the drawing) is exposed within the socket 26 and a connecting terminal 15a of the card 15 is clamped between the first terminal and an inner lateral side of the socket 26 to be fixed thereto. Hence, the card 15 is unable to escape from the socket 26 even if the entrance of the socket 26 is open due to the plane type antenna 30 projected from the upper side of the body 10.

For this, a recess is preferably formed at the connecting terminal 15a of the card 15 and the first terminal is preferably fitted in the recess to contact with. Namely, when the card 15 is inserted in the socket 26, the first terminal slides along with the connecting terminal so that a tip of the first terminal is fitted in the recess. Hence, the card 15 inserted in the socket 26 is not separated with ease.

A connecting portion connected to a radio communication signal transmitting/receiving unit provided within the body 10 is provided over the entrance of the socket 26. The plane type antenna 30 is brought into contact with the connecting portion.

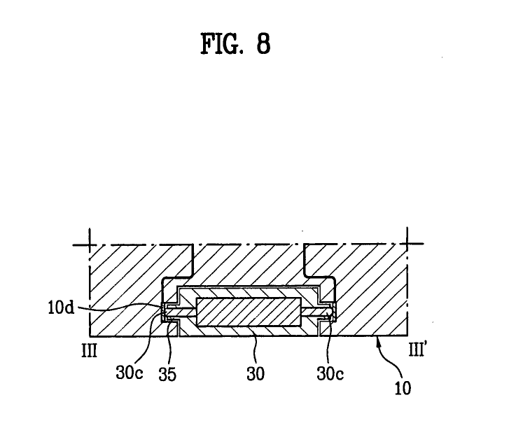

For example, a terminal 30c is provided at an end of a hinge shaft 35 of the antenna 30 and a terminal 10d is provided on a recess for receiving the hinge shaft 35 as shown in FIG. 8. The terminal 30c is electrically connected with a body of the antenna 30 and the terminal 10d is electrically connected with the radio communication signal transmitting/receiving unit provided within the body 10. The terminals 10d and 30c contact with each other when the antenna 30 opens/closes the entrance of the socket 26. Therefore, the antenna 30 always communicates with the radio communication signal transmitting/receiving unit through the terminals 10d and 30c, and thereby transmission and reception signals of the device are delivered via the plane type antenna.

Accordingly, the present invention provides the following effects or advantages.

First of all, it is unnecessary to provide a separate cover since the entrance of the socket for loading the card therein is opened/closed by the plane type antenna. Hence, the overall volume of the mobile communication device can be reduced.

Secondly, as the plane type antenna is joined to one lateral side of the body by the sliding or hinge mechanism to selectively open/close the entrance of the socket, it is able to prevent the plane type antenna from being broken or lost due to long-term use.

Thirdly, portability of the mobile communication device is enhanced since the plane type antenna is selectively projected upwardly from the body of the device. Namely, the plane type antenna is fixed to one lateral side of the body in case that the mobile communication device is put in a user's pocket. Hence, the plane type antenna avoids projecting upward, thereby preventing its breakage.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile communication device comprising:
a body including elements performing wireless mobile communications and auxiliary functions;
a socket provided to one side of the body to compensate functions of the body and to detachably receive a card for storing data; and
a plane type antenna connected to a rim of the socket to transmit/receive wireless communication signals.

2. The mobile communication device of claim 1, wherein the plane type antenna selectively opens/closes an entrance of the socket.

3. The mobile communication device of claim 1, wherein the plane type antenna slides along one lateral side of the body.

4. The mobile communication device of claim 3, wherein a guide portion recessed inward is provided to the one lateral side of the body to guide a movement of the plane type antenna.

5. The mobile communication device of claim 4, wherein guide grooves are provided to both sides of the guide portion, respectively and wherein fitting protrusions are provided to both sides of the plane type antenna to be fitted in the guide grooves, respectively.

6. The mobile communication device of claim 3, wherein the socket is provided to an upper part of one lateral side of the body and wherein the plane type antenna projects from an upper side of the body to be fixed thereto when the socket is open.

7. The mobile communication device of claim 6, wherein a hanging protrusion is provided to the plane type antenna and wherein a hanging recess is provided to an upper part of the socket to lock the hanging protrusion therein.

8. The mobile communication device of claim 1, wherein one end of the plane type antenna is rotatably connected to one lateral side of the body and wherein the other end of the plane type antenna is selectively fixed to the one lateral side of the body.

9. The mobile communication device of claim 8, wherein the plane type antenna is rotated centering on a rotational axis parallel to the one lateral side of the body.

10. The mobile communication device of claim 8, wherein a guide portion recessed inward is provided to the one lateral side of the body to receive the plane type antenna therein.

11. The mobile communication device of claim 10, wherein one end of the plane type antenna is joined to the one lateral side of the body using a hinge and wherein the other end of the plane type antenna is selectively fixed to the one lateral side of the body using a hook.

12. The mobile communication device of claim 8, wherein if the plane type antenna is fully turned upwardly, the plane type antenna is held by the one lateral side of the body to sustain an upwardly projecting posture.

13. The mobile communication device of claim 1, wherein the plane type antenna comprises a micro-strip board.

14. The mobile communication device of claim 1, wherein a first terminal is exposed within the socket and wherein a connecting terminal of the card is clamped between the first terminal and an inner lateral side of the socket to be fixed thereto.

15. A mobile communication device comprising:
a body including elements performing wireless mobile communications and auxiliary functions;
a socket provided to one side of the body to compensate functions of the body and to detachably receive a card for storing data; and
a plane type antenna sliding to move along a guide portion to open/close the socket and to transmit/receive wireless communication signals wherein the guide portion is recessed inward from a rim of the socket to guide a movement of the pane type antenna.

16. A mobile communication device comprising:
a body including elements performing wireless mobile communications and auxiliary functions;
a socket provided to one side of the body to compensate functions of the body and to detachably receive a card for storing data;
a plane type antenna opening/closing an entrance of the socket, the plane type antenna having one end rotatably connected centering on a rotational axis parallel to one lateral side of the body and the other end selectively fixed to the one lateral side of the body, the plane type antenna transmitting/receiving wireless communication signals; and
a guide portion recessed inward from a rim of the socket to receive the pane type antenna therein.
